(19) United States
(12) Patent Application Publication
(10) Pub. No.: US 2006/0132290 A1
(43) Pub. Date: Jun. 22, 2006

(54) Automatic message tag update system and the method thereof

(76) Inventors: Chii-Yah Yuan, Hsinchu City (TW); Yi-Fei Luo, Jhudong Township (TW); Hon-Yue Chou, Taipei City (TW); Teh-Chang Wu, Yonghe City (TW); Leii H. Chang, Cyonglin Township (TW); Ho-Hsin Li, Hsinchu City (TW)

Correspondence Address: RABIN & BERDO, P.C., Suite 500, 1101 14 St., N.W., Washington, DC, 20005, US

(21) Appl. No.: 11/234,178

(22) Filed: Sep. 26, 2005

(30) Foreign Application Priority Data
Dec. 22, 2004 (TW) 093139949

(51) Int. Cl. H04Q 5/22

(52) U.S. Cl. 340/10.51; 340/10.41

(57) ABSTRACT

The invention provides an automatic message Tag update system and method thereof, which comprises message Tag, message transmission apparatus, and message application system. It provides receive, presentation, collection, and spread of each message on the message Tag via wire or wireless method, and it comprises two types, one is capable of data collecting, and another is not capable of data collecting. The invention can be applied in dividing, cataloging, prompting, messaging, explaining, introducing, pricing, and signing objects for transmitting and presenting, and can be applied in collecting, transmitting, presenting, connecting, and coordinating applications.

### BACKGROUND OF THE INVENTION

1. Field of the Invention

The present invention is a automatic message Tag update system and the method thereof, particularly to an automatic message Tag update system with two message Tags respectively to one which is capable of data collecting and another which is not capable of data collecting, Both them can utilize wire or wireless method to transmit message for receiving, presenting, collecting, and spreading purpose.

2. Description of the Prior Art

A typical radio frequency identification (RFID) system is composed of readers and Tags. The major function of it is to utilize radio frequency for identifying object and collecting data. Due to its characteristics of non-contact store-and-read function, data encryption function, and concurrently reading multi-Tag function, it can integrate various data system, promote industrial logistics and automated transportation, and improve service and efficiency.

Nowadays, RFID Tag is major applied in commodities to replace traditional barcode. It can realize real-time monitoring system of raw materials, semi-finished materials, finished products, transportation, storage, logistics, slotting, sales, and even returned goods. Which can dramatically promote industrial logistics and automated transportation, and can reduce error, then improve data transparency and management efficiency of supplying chain data.

However, the potentiality of RFID Tag is powerful, and needed to be developed. For example, RFID Tag can combine with sensing elements to become an apparatus with automatic data collecting ability. Moreover, the RFID Tag itself does not provide method of message presentation, which means it has to present message via proper apparatus, such as RFID Tag reader. One of the key factors to develop application of RFID Tag is how to achieve personal message, and how to make convenient maintain, after the RFID Tag is able to provide multi-functions in the future.

### SUMMARY OF THE INVENTION

One object of the present invention is to provide an automatic message Tag update system with improved application of RFID Tag and the method thereof.

The plate method of the invention is to provide message renew system receiving, presenting, collecting, and spreading each message by wire or wireless method, which comprises two types, one is capable of data collecting and another is not capable of data collecting. It can be applied in dividing and coordinating objects, cataloging and, prompting or laying out products, message transmission, explaining and, introducing or explaining objects, instantaneously pricing, and signing objects.

Wherein for the message Tag not capable of data collecting, it is applied in one-way message transmission application; and for the message Tag capable of data collecting, it is applied in both one-way message transmission and message transmission and application.

The application of message transmission, which catches to-be-used logic and data from an industrial application system via interface module, then logical module, determines if it is necessary to designate receiver, then transmits message data and receiving message data via message transmitting apparatus. And the application of message announcement, which spreads message by message Tag, then the message transmitting apparatus receives the message, after that, the message transmitting apparatus determines if the source of the message is recognized; if it is, then identifying module identifies each individual and status module distinguishes status, after that it catches to-be-used logic and data from an industrial application system via interface module, then the logic module designates processing method in accordance with acquired logic, and processes the received message in designated processing method.

### BRIEF DESCRIPTION OF THE DRAWINGS

The drawings disclose an illustrative embodiment of the present invention which serves to exemplify the various advantages and objects hereof, and are as follows:

FIG. 1 is a perspective view of system of the invention;

FIG. 2 is a perspective view of organization of the invention;

FIG. 3 is a perspective view of a message Tag not capable of data collecting of the invention;

FIG. 4 is a perspective view of a message Tag capable of data collecting of the invention;

FIG. 5 is a flow chart of message transmission of the invention;

FIG. 6 is a flow chart of message announcement of the invention;

FIG. 7 is a flow chart of message receiving of the invention;

FIG. 8 is a flow chart of message collection of the invention;

FIG. 9 is a flow chart of message process of the invention;

FIG. 10 is a flow chart of message presentation of the invention; and

FIG. 11 is a flow chart of message spreading of the invention.

parts list

| | | | |
|---|---|---|---|
| 1 | message Tag | 11 | presentation element |
| 12 | communication element | 13 | Tag |
| 131 | Storage | 132 | processor |
| 14 | input element | 15 | sense element |
| 2 | message transmission | 3 | message application system |
| | apparatus | | |
| 31 | identification module | 32 | status module |
| 33 | logic module | 34 | interface module |
| 4 | industrial application system | | |

### DETAILED DESCRIPTION OF THE PREFERRED EMBODIMENT

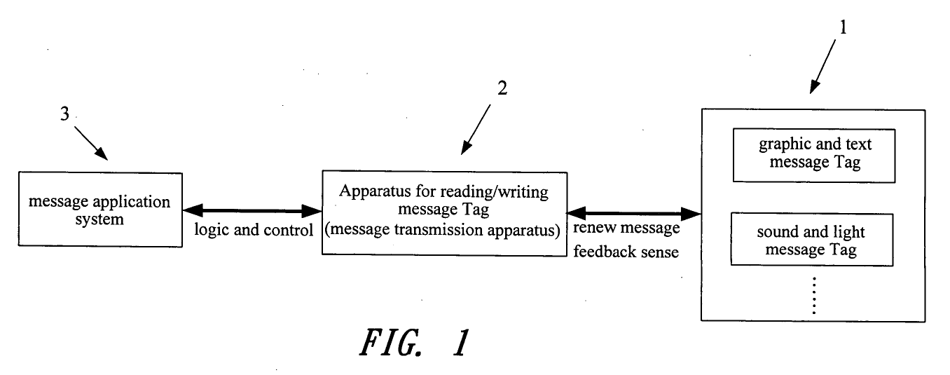

Referring to FIG. 1. The invention provides an automatic message Tag update system comprising message Tag 1, message transmission apparatus 2, and message application system 3. The message Tag 1 is applied to provide message identification, the message transmission apparatus 2 is capable of reading and writing the message Tag 1 for reading and writing the contains of the message Tag 1, and the message application system 3 is applied to process the message from the message Tag 1 received by the message transmission apparatus 2, and transfer it into a ready-to-use information, or applied to transmit update message to the message Tag 1 via the message transmission apparatus 2. Wherein the message transmission apparatus 2 can be a single read/write electric apparatus, e.g. RFID reader, or IC card reader, or can be a computer apparatus capable of reading/writing the message Tag, or can be attached in the message application system.

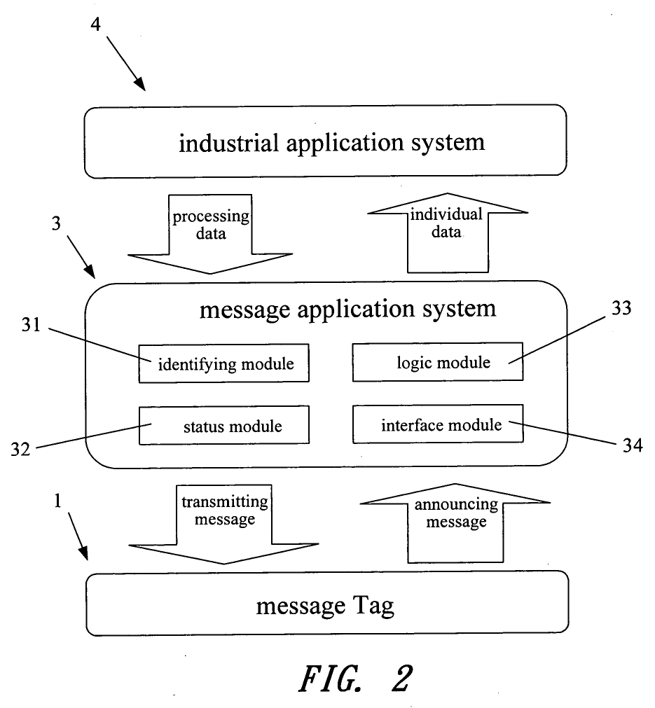

Referring to FIG. 2. The message application system 3 comprises at least identification function, status and logic process function, and communication process function. Each of those functions can be comprised in one module or be separated in different modules, e.g. identification module 31, status module 32, logic module 33, interface module 34, etc, for the industrial application system 4. The identification module 31 is for identifying individual message Tag. By reading identification data via the reading apparatus to distinguish the logic individual of an enterprise or organization. The status module 32 for knowing and recording. The logic module 33 which executes different processes in response to individual message Tag. The interface module 34 is industrial application system and message transmission apparatus for communicating with industrial application system, which is a combination of software interface and hardware interface.

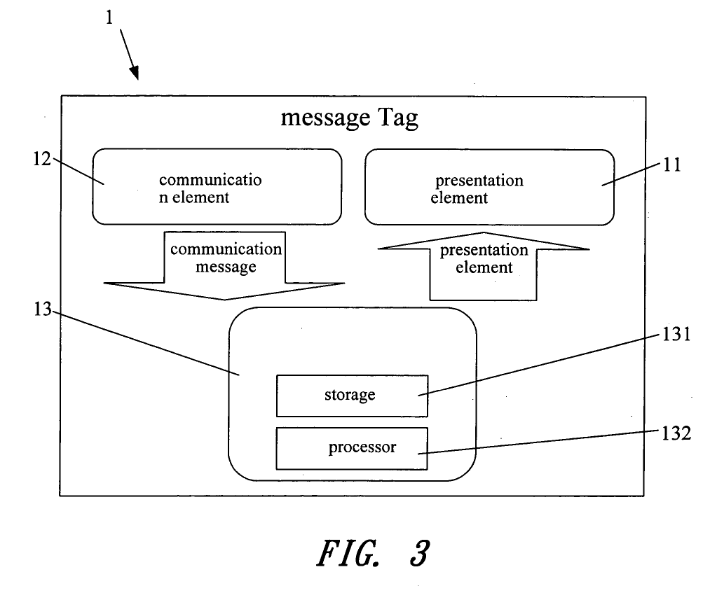

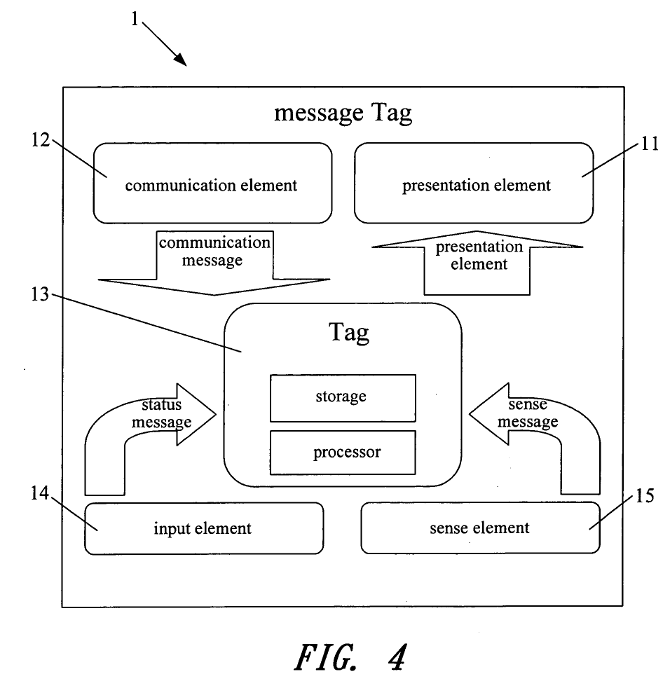

FIG. 3 and FIG. 4 are the perspective views of a message Tag of the invention comprising a message Tag 1 not capable of data collecting and a message Tag 1 capable of data collecting. The two message Tags are almost the same, each one is composed of any shape, size, and material. Wherein the Tag 13 comprises a storage 131 and a processor 132 for storing and processing data. The space of storage 131 can be divided into waiting-process partition, waiting-present partition, status data partition, sense data partition, and etc. The message Tag 1 is an identifiable tag, which is distinguishable to be an unique individual and comprises forms in RFID Tag, IC card, and etc.

The message Tag 1 comprises a presentation element 11 for presenting message. The presentation element 11 can be located on any surface of the message Tag 1, or inside the message, Tag 1, or located outside the message Tag 1 but linking to the message Tag 1 via wire or wireless method. The presentation element 11 transfers the examined message of the message Tag 1 into graphic, text, sound, light, smell, vibration, or temperature forms in accordance with electric, optical, and chemical theories. And the presentation element 11 can be a continuously powered apparatus, or a discontinuously powered apparatus. The continuously powered apparatus means it needs continuous power supply during presentation, and the discontinuously powered apparatus means it needs power supply only when updateing the message. The continuously powered apparatus comprises liquid crystal display (LCD), light emitting diode (LED), thermal light emitting body, organic LED (OLED), light emitting polymer (LEP), speaker, chemical smell generator, vibrator, temperature generator, and etc. The discontinuously powered apparatus comprises electronic ink (E-Ink).

The message Tag 1 comprises a communication element 12 for transmitting data. The communication element 12 can be located on any surface of the message Tag 1, or inside the message Tag 1, or located outside the message Tag 1 but linking to the message Tag 1 via wire or wireless method. The communication element 12 transmits data via wire or wireless electric apparatus comprising radio frequency (RF), Bluetooth, IrDA, USB, RS232, IEEE1394, and etc. It also applies structure such as point-to-point, broadcast, client-server, and N-tier architecture for communication. And the communication element 12 can apply functions of message coding or identification to ensure the transmitting data is correct, which comprises read data to verify, one-way hash function to generate message digest, or cyclic redundancy check.

FIG. 4 is a perspective view of message Tag 1 capable of data collecting, which can be divided into three different structures. First structure comprises only an input element 14, second structure comprises only a sense element 15, and third structure comprises both an input element 14 and sense element 15. Wherein, for the message Tag 1 with the input element 14, the input element 14 can be located on any surface of the message Tag 1, or inside the message Tag 1, or located outside the message Tag 1 but linking to the message Tag 1 via wire or wireless method. The message Tag 1 controls status changing or data collecting via the input apparatus 14 by man-made direct or indirect input. Wherein the input element 14 can be a button, a switch, or a knob. And, for the message Tag 1 comprising the sense element 15, the sense element 15 can be located on any surface of the message Tag 1, or inside the message Tag 1, or located outside the message Tag 1 but linking to the message Tag 1 via wire or wireless method. The message Tag 1 controls status changing or data collecting via the sense element 15, and the sense element 15 can man-made or automatically collect or stop collecting data by starting it up or shutting it down.

The invention of an automatic message Tag update method accomplished in accordance with the above-mentioned structure provides receive, presentation, collection, and spread of each message on the message Tag 1 via wire or wireless method, and it comprises two types, one is capable of data collecting, and another is not capable of data collecting. The invention can be applied in dividing and coordinating objects, cataloging and prompting laying out products, message transmission, explaining, and introducing objects, instantaneously pricing, and signing objects. For the message Tag 1 not capable of data collecting, it is applied in one-way message transmission; and for the message Tag 1 capable of data collecting, it is applied in both one-way message transmission and message transmission and announcement. The application of message transmission catches to-be-used logic and data from an industrial application system 4 via an interface module 34, then transmits the logic and data to a logical module 33, which determines if it is necessary to designate receiver (the receiver is generally indicated as the message transmission apparatus 2 or the message Tag 1), then transmits message data and receiving message data via message transmitting apparatus 2. And the application of message announcement spreads message by message Tag 1, then the message transmitting apparatus 2 receives the message, after that, the message transmitting apparatus 2 determines if the source of the message is recognized; if it is, then identifying module 31 identifies each individual and status module 32 distinguishes status, after that it catches to-be-used logic and data from an industrial application system 4 via interface module 34, then the logic module designates processing method in accordance with acquired logic, and processes the received message in designated processing method.

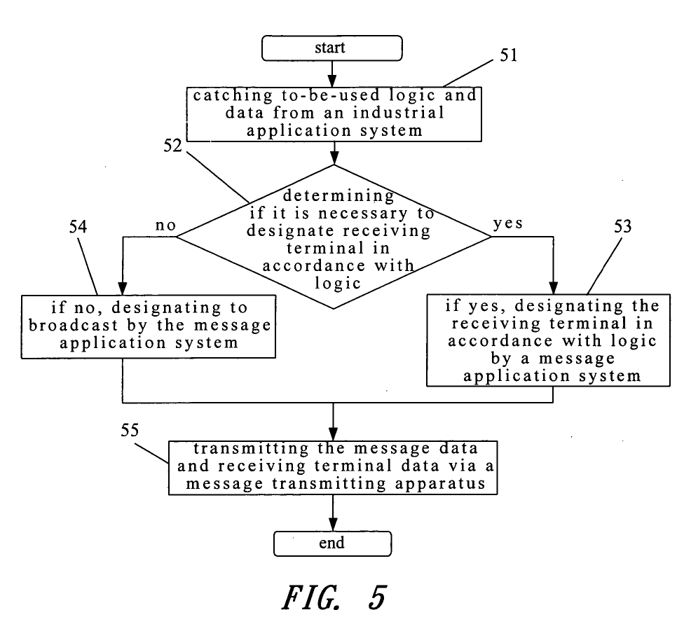

FIG. 5 is a flow chart of message transmission of the invention, which comprises:

51 catching to-be-used logic and data from an industrial application system;

52 determining if it is necessary to designate receiving terminal in accordance with logic;

53 if YES, designating the receiving terminal in accordance with logic by a message application system;

54 if NO, designating to broadcast by the message application system;

55 transmitting the message data and receiving terminal data via a message transmitting apparatus.

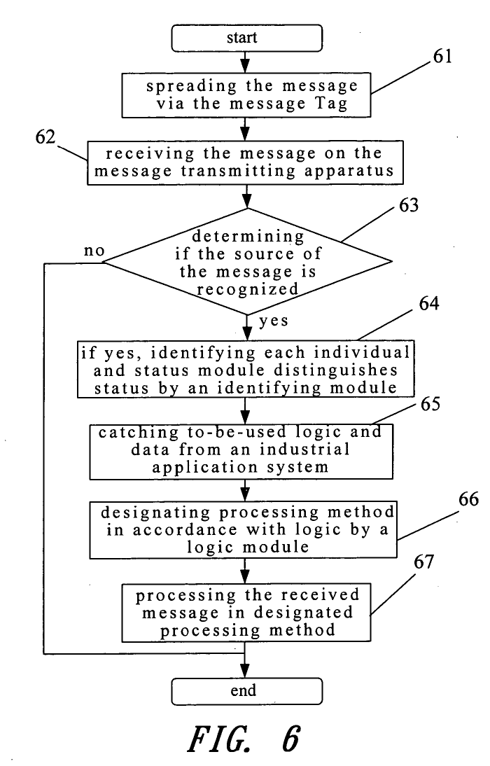

FIG. 6 is a flow chart of message announcement of the invention, which comprises:

61 spreading the message via the message Tag;

62 receiving the message on the message transmitting apparatus;

63 determining if the source of the message is recognized, if NO, terminating the flow;

64 if YES, identifying each individual and status module distinguishes status by an identifying module;

65 catching to-be-used logic and data from an industrial application system;

66 designating processing method in accordance with logic by a logic module;

67 processing the received message in designated processing method.

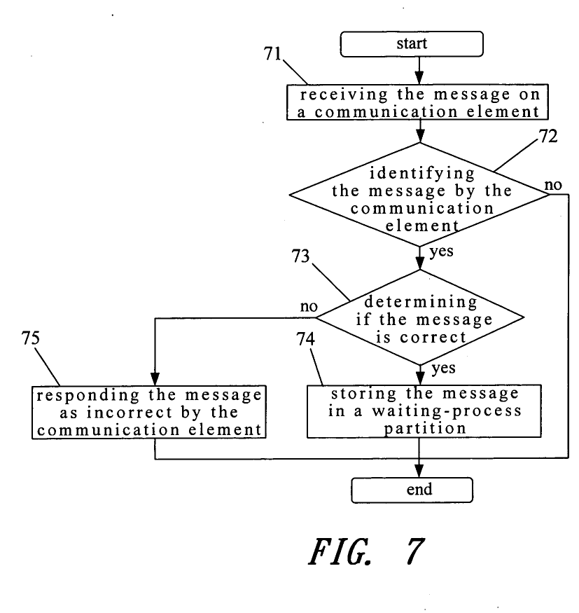

FIG. 7 is a flow chart of message receiving of the invention, which comprises:

71 receiving the message on a communication element;

72 identifying the message by the communication element, if NO, terminating the flow;

73 if YES, determining if the message is correct;

74 if YES, storing the message in a waiting-process partition;

75 if NO, responding the message as incorrect by the communication element.

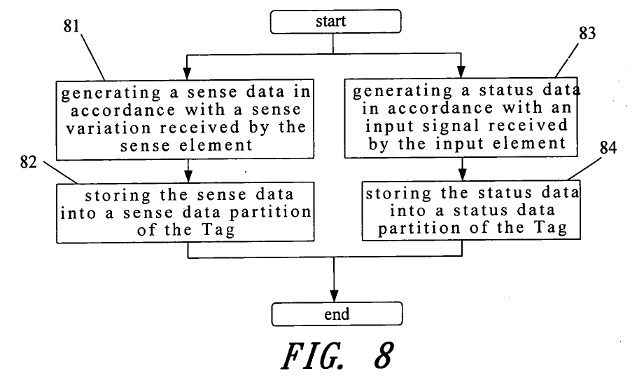

FIG. 8 is a flow chart of message collection of the invention, which comprises sense element path and input element path:

sense element path

81 generating a sense data in accordance with a sense variation received by the sense element;

82 storing the sense data into a sense data partition of the Tag;

input element path:

83 generating a status data in accordance with an input signal received by the input element;

84 storing the status data into a status data partition of the Tag.

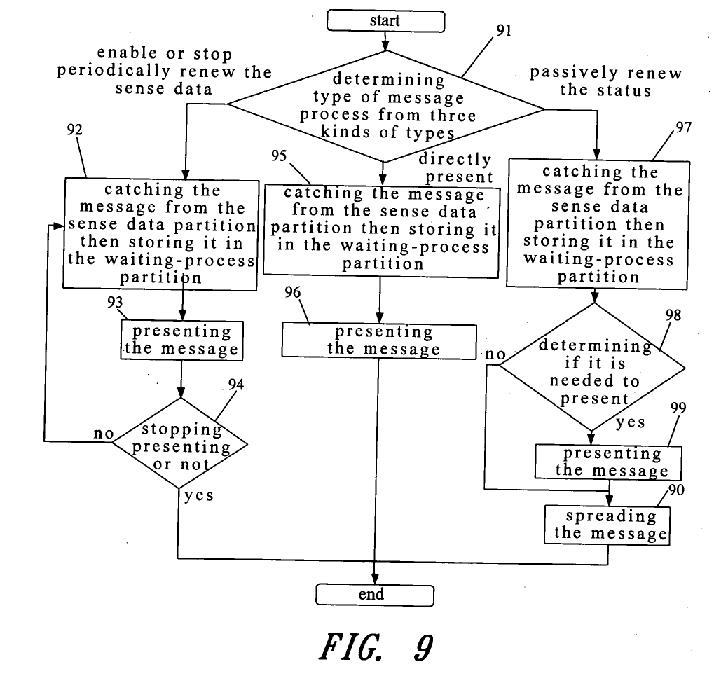

FIG. 9 is a flow chart of message process of the invention, which comprises:

91 determining type of message process from three kinds of types;

type I enable or stop periodically update the sense data

92 catching the message from the sense data partition then storing it in the waiting-process partition;

93 presenting the message;

94 stopping presenting or not, if YES, terminating the flow, if NO, catching the message again from the sense data partition then storing it in the waiting-process partition; type II directly present

95 catching the message from the sense data partition then storing it in the waiting-process partition;

96 presenting the message; type III passively update the status

97 catching the message from the sense data partition then storing it in the waiting-process partition;

98 determining if it is needed to present, if NO, directly spreading the message;

99 if YES, presenting the message;

90 spreading the message.

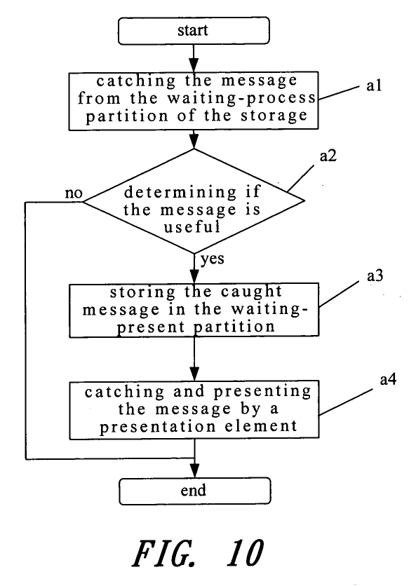

FIG. 10 is a flow chart of message presentation of the invention, which comprises:

a1. catching the message from the waiting-process partition of the storage;

a2. determining if the message is useful by the processor, if NO, directly terminating the flow;

a3. if YES, storing the caught message in the waiting-present partition;

a4. catching and presenting the message by a presentation element.

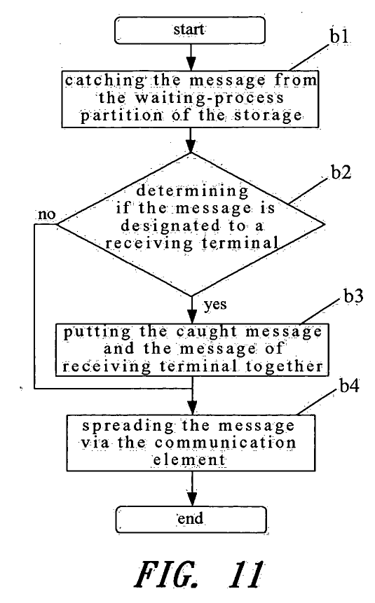

FIG. 11 is a flow chart of message spreading of the invention, which comprises:

b1. catching the message from the waiting-process partition of the storage;

b2. determining if the message is designated to a receiving terminal;

b3. if YES, putting the caught message and the message of receiving terminal together, if NO, skipping the step;

b4. spreading the message via the communication element.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An automatic message Tag update system, which comprises:
a message Tag capable of identifying individual, presenting message, and collecting data;
a message transmission apparatus capable of reading and/or writing the message Tag, for reading and updateing the message Tag; and
a message application system, for processing the message from the message Tag received by the message transmission apparatus, and transferring it into a ready-to-use information, or for transmitting update message to the message Tag via the message transmission apparatus, wherein the message application system can be an independent application system or attached to an industrial application system.

2. The system of claim 1, wherein the message transmission apparatus can be a single read and write electric apparatus, such as RFID reader, or IC card reader, or can be a computer apparatus capable of reading and writing the message Tag, or can be attached in the message application system.

3. The system of claim 1, wherein the message application system comprises at least identification function, status and logic process function, and communication process function, and each of those functions can be comprised in one module or separated in different modules, such as identification module, status module, logic module, and interface module; wherein the identification module is a process module of the message Tag application system for identifying individual Tag by reading identification data via the reading apparatus to distinguish the logic individual of an enterprise or organization, the status module is a status module of the message Tag application system for knowing and recording the status of specific individual then storing related data in kinds of data structure, the logic module is a logic process module of the message Tag application system for specific individual Tag, which is a dynamic execution engine and can load and execute a set of procedures made for application in accordance with logic demand, and the interface module is a communication module of the message Tag application system for communicating with the industrial application system and the message transmission apparatus, which is a combination of software interface and hardware interface.

4. The system of claim 1, wherein the message Tag is composed of any shape, size, and material, and comprises a storage and a processor.

5. The system of claim 1, wherein the message Tag is an identifiable tag, which is distinguishable to be an unique individual and comprises forms in such as RFID Tag and IC card.

6. The system of claim 1, wherein the message Tag comprises a storage and (a processor) for storing and processing data and the space of the storage can be divided into such as waiting-process partition, waiting-present partition, status data partition, and sense data partition.

7. The system of claim 1, wherein the message Tag comprises a presentation element for presenting message, and the presentation element can be located on any surface of the message Tag, or inside the message Tag, or located outside the message Tag but linking via wire or wireless method.

8. The system of claim 7, wherein the presentation element transfers the examined message of the message Tag 1 into graphic, text, sound, light, smell, vibration, or temperature forms in accordance with electric, optical, and chemical theories.

9. The system of claim 7, wherein the presentation element can be a continuously powered apparatus, or a discontinuously powered apparatus, and the continuously powered apparatus needs continuous power supply during presentation, the discontinuously powered apparatus needs power supply only when updateing the message.

10. The system of claim 9, wherein the continuously powered apparatus comprises such as liquid crystal display (LCD), light emitting diode (LED), thermal light emitting body, organic LED (OLED), light emitting polymer (LEP), speaker, chemical smell generator, vibrator, temperature generator.

11. The system of claim 9, wherein the discontinuously powered apparatus comprises such as electronic ink (E-Ink).

12. The system of claim 1, wherein the message Tag can comprises a sense element, and the sense element can be located on any surface of the message Tag, or inside the message Tag, or located outside the message Tag but linking via wire or wireless method.

13. The system of claim 12, wherein the sense element can man-made or automatically collect or stop collecting data by starting it up or shutting it down.

14. The system of claim 12, wherein the sense element can be sensor of temperature, humidity, pressure, vibration, light, sound, smell, balance, direction, and acceleration.

15. The system of claim 1, wherein the message Tag can comprise the input element, which can be located on any surface of the message Tag, or inside the message Tag, or located outside the message Tag but linking via wire or wireless method, and processes status changing or data collecting via the input apparatus.

16. The system of claim 1, wherein the input element can be a button, a switch, or a knob.

17. The system of claim 1, wherein the message Tag comprises a communication element, which can be located on any surface of the message Tag, or inside the message Tag, or located outside the message Tag but linking via wire or wireless method.

18. The system of claim 17, wherein the communication element transmits data via wire or wireless electric apparatus comprising radio frequency (RF), Bluetooth, IrDA, USB, RS232, IEEE1394, and applies structure such as point-to-point, broadcast, client-server, and N-tier architecture for communication.

19. The system of claim 1, wherein the communication element can apply message coding or identification to ensure the transmitting data is correct, which comprises read data to verify, one-way hash function to generate message digest, or cyclic redundancy check.

20. A method of automatic message Tag update system comprising steps of:
providing receiving, presenting, collecting, and spreading of messages via a message Tag, wherein the message Tag comprises two types, one is capable of data collecting and another is not capable of data collecting, and the message Tag capable of data collecting can collect data via the sense apparatus or the input element;
transmitting the message via a message transmission apparatus with function of reading and writing the message Tag in accordance with wire or wireless method, and then catching the contains of the message Tag; and
processing the message Tag received by the message transmission apparatus by a message application system, and then rewriting a updated message into the message Tag by controlling the message transmission apparatus.

21. The method of claim 20, wherein the message Tag not capable of data collecting is applied in one-way message transmission.

22. The method of claim 20, wherein the message Tag capable of data collecting is applied in both one-way message transmission and message transmission and announcement.

23. The method of claim 20, wherein the message transmission comprises catching to-be-used logic and data from an industrial application system via interface module, transmitting the logic and data to logical module, which determines if it is necessary to designate receiving terminal (the receiving terminal here is generally indicated as the message transmission apparatus or the message Tag), designating to broadcast or specific receiving terminal in accordance with demands, and transmitting the message data and receiving terminal data via the message transmitting. apparatus.

24. The method of claim 20, wherein the message announcement comprises steps of:
spreading the message via the message Tag;
receiving the message by the message transmission apparatus;
determining if the source of the message is recognized;
if YES, identifying individual and distinguishing status by an identifying module and a status module;
catching to-be-used logic and data from the industrial application system via the interface module;
designating processing method in accordance with logic by the logic module and processing the received message in designated processing method.
